(19) United States
(12) Patent Application Publication
(10) Pub. No.: US 2010/0034425 A1
(43) Pub. Date: Feb. 11, 2010

(54) METHOD, APPARATUS AND SYSTEM FOR GENERATING REGIONS OF INTEREST IN VIDEO CONTENT

(75) Inventors: Shu Lin, San Diego, CA (US); Izzat Hekmat Izzat, Santa Clarita, CA (US)

Correspondence Address: Robert D. Shedd, Patent Operations;THOMSON Licensing LLC, P.O. Box 5312, Princeton, NJ, 08543-5312, US

(73) Assignee: THOMSON LICENSING, Boulogne-billancourt (FR)

(21) Appl. No.: 12/311,512

(22) PCT Filed: Oct. 20, 2006
(86) PCT No.: PCT/US2006/041223

§ 371 Date: Apr. 1, 2009

(51) Int. Cl. G06K 9/00; G06F 3/033; G06K 9/36

(52) U.S. Cl. 382/103; 345/163; 382/232

(57) ABSTRACT

A method, apparatus and system for generating regions of interest in a video content include identifying the program content of received video content, categorizing the scene content of the identified program content and defining at least one region of interest in at least one of the characterized scenes by identifying at least one of a location and an object of interest in the scenes. In one embodiment of the invention, a region of interest is defined using user preference information for the identified program content and the categorized scene content.

### TECHNICAL FIELD

The present invention generally relates to video processing, and more particularly, to a system and method for generating regions of interest (ROI) in video content, in particular, for display in video playback devices.

### BACKGROUND OF THE INVENTION

Mobile and handheld devices with video displays have become very popular in recent years. However, due to their small size most handheld devices cannot display video or images at a high resolution. Typically, after a handheld device receives a video signal, such as from broadcast standard definition (SD) or high definition (HD), the video has to be down sampled to the size of the handheld device screen resolution, to Common Intermediate Format (CIF) or even quarter common intermediate format (QCIF). A CIF is commonly defined as one-quarter of the ‘full’ resolution of the video system for which it is intended.

As a result of such downsizing, sometimes the most interesting parts of the video are lost. For example, balls can become invisible in sports videos such as football, tennis, etc. As such, normal down sampling will not work well in such cases and with such devices. Furthermore, simple cropping of an image is not feasible either, because the region of interest is often moving, and furthermore, a camera can be panning or zooming.

Some efforts (e.g. Xinding Sun et. al., “Region of Interest Extraction and Virtual Camera Control Based on Panoramic Video Capturing”, IEEE Trans. Multimedia, Vol. 7 No. 5, pp. 981-990, Oct. 11, 2005) have been made for generating regions of interest at the encoder side. For example, a ROI can be generated according to common sense or based on a visual attention model. In such cases, metadata of a ROI is required to be sent to a decoder. The decoder uses the information to play back the video within the ROI.

However, there are a number of disadvantages with this approach. Firstly, every receiver gets the same ROI, yet different people have different tastes in what they consider a region of interest for viewing. Secondly, since the ROI is generated automatically, if something goes wrong, then everyone will receive the wrong information which furthermore cannot be corrected at the receiver. Thirdly, metadata is required to be sent with the video signals, which thus increases bit rate. Accordingly, a system and method for generating regions of interest in a video which avoids the limitations and deficiencies of the prior art is highly desirable.

### SUMMARY OF THE INVENTION

A method, apparatus and system in accordance with various embodiments of the present invention addresses the deficiencies of the prior art by providing region of interest (ROI) detection and generation based on, in one embodiment, user preference(s), for example, at the receiver side.

In one embodiment of the present invention, a method for generating a region of interest in video content includes identifying at least one programming type in the video content, categorizing the scenes of the programming types of the video content and defining at least one region of interest in at least one of the categorized scenes by identifying at least one of a location and an object of interest in the scenes. In one embodiment of the invention, a region of interest is defined using user preference information for the identified program content and the characterized scene content.

In an alternate embodiment of the present invention, an apparatus for generating a region of interest in video content includes a processing module configured to perform the steps of identifying at least one programming type of the video content, categorizing the scenes of at least one of the programming types, and defining at least one region of interest in at least one of the scenes by identifying at least one of a location and an object of interest in the scenes. In one embodiment of the present invention, the apparatus includes a memory for storing identified programming types and categorized scenes of the video content and a user interface for enabling a user to identify preferences for defining regions of interest in the identified programming types and categorized scenes of the video content.

In an alternate embodiment of the present invention, a system for generating a region of interest in video content includes a content source for broadcasting the video content, a receiving device for receiving the video content and configuring the received video content for display, a display device for displaying the video content from the receiving device, and a processing module configured to perform the steps of identifying at least one programming type of the video content, categorizing scenes of at least one of the programming types, and defining at least one region of interest in at least one of said the categorized scenes by identifying at least one of a location and an object of interest in the scenes. In one embodiment of the present invention, the processing module is located in the receiving device and the receiving device includes a memory for storing identified programming types and categorized scenes of the video content. In such an embodiment, the receiving device can further include a user interface for enabling a user to identify preferences for defining regions of interest in the identified programming types and categorized scenes of the video content. In an alternate embodiment, the processing module is located in the content source and the content source includes a memory for storing identified programming types and categorized scenes of the video content. In such an embodiment, the content source can further include a user interface for enabling a user to identify preferences for defining regions of interest in the identified programming types and categorized scenes of the video content.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a receiver for defining and generating a region of interest in accordance with an embodiment of the present invention;

FIG. 2 depicts a high level block diagram of a system for defining and generating a region of interest in accordance with an embodiment of the present invention;

FIG. 3 depicts a high level block diagram of a of a user interface suitable for use in the receiver of FIGS. 1 and 2 in accordance with an embodiment of the present invention;

FIG. 4 depicts a flow diagram of a method of the present invention in accordance with an embodiment of the present invention; and

FIG. 5 depicts a flow diagram of a method for defining a region of interest based on user input in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for generating regions of interest (ROI) in video content. Although the present invention will be described primarily within the context of a broadcast video environment and a receiver device, the specific embodiments of the present invention should not be treated as limiting the scope of the invention. It will be appreciated by those skilled in the art and informed by the teachings of the present invention that the concepts of the present invention can be advantageously applied in any environment and or receiving and transmitting device for generating regions of interest (ROI) in video content. For example, the concepts of the present invention can be implemented in any device configured to receive/process/display/transmit video content, such as portable handheld video playback devices, handheld TV's, PDAs, cell phones with AV capabilities, portable computers, transmitters, servers and the like.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

In accordance with various embodiments of the present invention, a method, apparatus and system for generating a region of interest (ROI) in video content provide a program library, a scene library and an object/location library, and include a region of interest module in communication with the libraries, the module being configured to generate customized regions of interest in received video content based on data from the libraries and user preferences. In various embodiments, users are enabled to define their preference(s) with regards to, for example, what area/object in the video they would like to select as a ROI for viewing. In an embodiment of the invention in which a server is broadcasting video content to multiple receivers, if something goes wrong in a local receiver, the errors only affect that one receiver, and can be easily corrected. A system in accordance with the present principles is thus more robust than prior available systems and enables a user to control and view a region or object of interest in video content with relatively higher resolution than previously available.

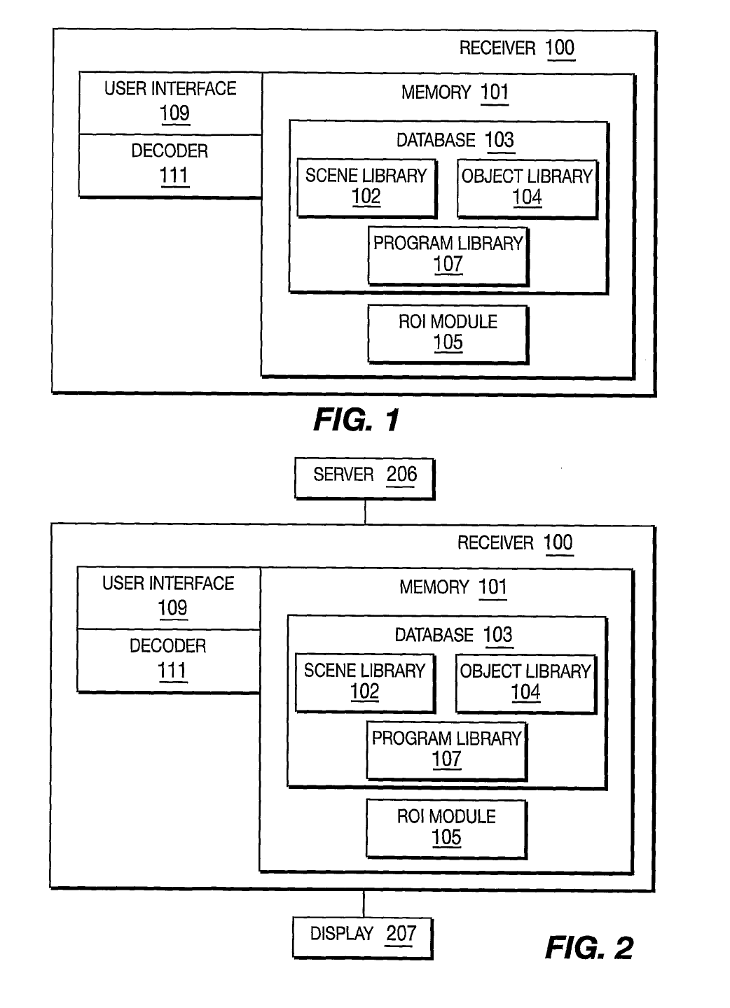

For example, FIG. 1 depicts a receiver for defining and generating a region of interest in accordance with an embodiment of the present invention. The receiver 100 of FIG. 1 illustratively comprises a memory means 101, a user interface 109 and a decoder 111. The receiver 100 of FIG. 1 illustratively comprises a database 103 and a region of interest (ROI) module 105. The database 103 of the receiver 100 of FIG. 1 illustratively comprises a program library 107, a scene library 102 and an object/location library 104. In one embodiment of the present invention, the program library 107, the scene library 102 and the object library 104 are configured to store various classified program types, scene types and object types, respectively, as will be described in greater detail below. The ROI module 105 of the receiver 100 of FIG. 1 can be configured to create a region(s) of interest in received video content in accordance with viewer inputs and/or pre-stored information in the program library 107, the scene library 102 and the object library 104. That is, a viewer can provide input to the receiver 100 via a user interface 109, with the resultant region(s) of interest being displayed to the viewer on a display.

For example, FIG. 2 depicts a high level block diagram of a system for defining and generating a region of interest in accordance with an embodiment of the present invention. The system 200 of FIG. 2 illustratively comprises a video content source (illustratively a server) 206 for providing video content to the receiver 100 of the present invention. The receiver, as described above, can be configured to create a region(s) of interest in received video content in accordance with viewer inputs entered via the user interface 109 and/or pre-stored information in the program library 107, the scene library 102 and the object library 104. The resultant region(s) of interest created are then displayed to the viewer on the display 207 of the system 200. Although in FIG. 1, the receiver 100 is illustratively depicted as comprising the user interface 109 and the decoder 111, in alternate embodiments of the present invention, the user interface 109 and/or the decoder 111 can comprise separate components in communication with the receiver 100. Furthermore, although in the system 200 of FIG. 2, the database 103 and the ROI module 105 are illustratively depicted as being located within the receiver 100, in alternate embodiments of the present invention, a database and a ROI module of the present invention can be included in the server 206 in lieu of or in addition to a database and a ROI module in the receiver 100. In such embodiments of the present invention, region of interest selections in video content can be performed in the server 206 and as such, a receiver receives video content that has already been assigned regions of interest. As such, the ROI module in the receiver would detect the ROI regions of interest defined by the server and apply such ROI regions of interest in content to be displayed. In addition, in such embodiments of the present invention, a server including a database and a ROI module of the present invention can further include a user interface for providing user inputs for creating regions of interest in accordance with the present invention.

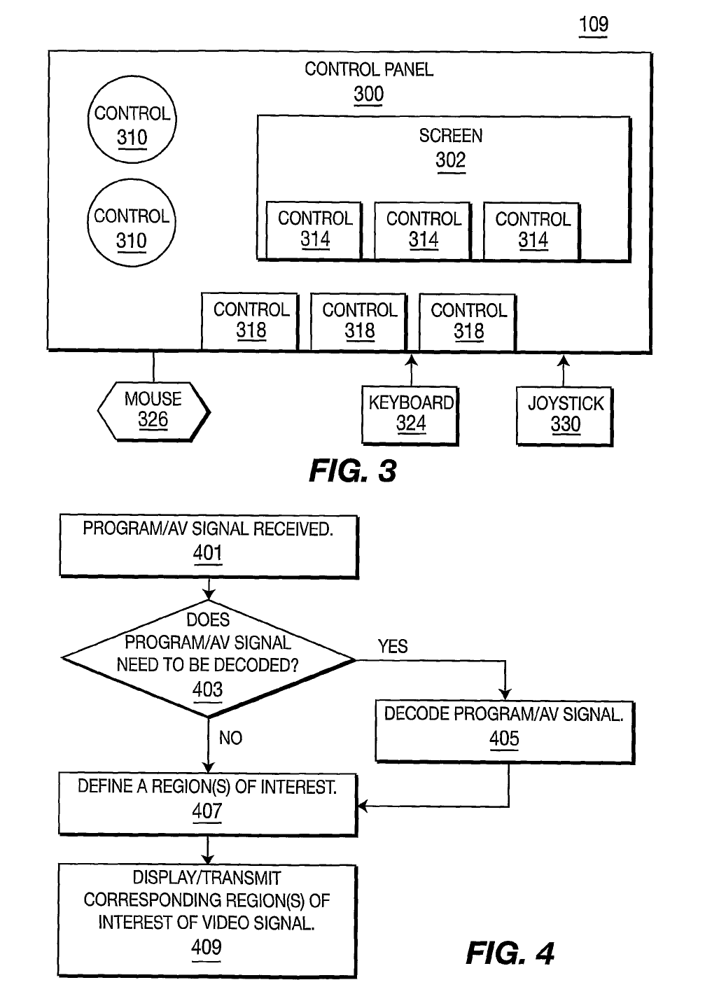

FIG. 3 depicts a high level block diagram of a of a user interface 109 suitable for use in the receiver 100 of FIGS. 1 and 2 in accordance with an embodiment of the present invention. As described above, the user interface 109 is provided for communicating viewer inputs for creating regions of interest in received video content in accordance with an embodiment of the present invention. The user interface 109 can include a control panel 300 having a screen or display 302 or can be implemented in software as a graphical user interface. Controls 310-326 can include actual knobs/sticks 310, keypads/keyboards 324, buttons 318-322 virtual knobs/sticks and/or buttons 314, a mouse 326, a joystick 330 and the like, depending on the implementation of the user interface 109.

In the embodiment of the present invention of FIG. 2, the server 206 communicates video content to the receiver 100. At the receiver 100, it is determined whether the received video content is encoded and needs to be decoded. If so, the video content is decoded by the decoder 111. After decoding the video content, the programming of the video content is identified. That is, in one embodiment of the present invention, information (e.g., electronic program guide information) obtained from the video content source (e.g., the transmitter) 206 can be used to identify the program types in the received video content. Such information from the video content source 206 can be stored in the receiver 100, in for example, the program library 107. In alternate embodiments of the present invention, user inputs from, for example, the user interface 109 can be used to identify the programming of the received video content. That is in one embodiment, a user can preview the video content using, for example, the display 207 and identify different program types in the display 207 by name or title. The titles or identifiers of the various types of programming of the video content identified via user input can be stored in the memory means 101 of the receiver 100 in, for example, the program library 107. In yet alternate embodiments of the present invention, a combination of both, information received from the content source 206 and user inputs from the user interface 109 can be used to identify the programming of the received video content.

In various embodiments of the present invention, program types that cannot be accurately categorized using the pre-stored information and/or user inputs can be treated as a new type of program, and can be accordingly added to the program library 107. Table 1 below depicts some exemplary program types.

TABLE 1
PROGRAM TYPES

Football
Car race
Basketball
Tennis
Talk show
Disney movie
News
Western
. . .
General

After identifying the program types in the video content, the scenes of the program types are categorized. That is similar to identifying the program types, in one embodiment of the present invention, information (e.g., electronic program guide information) obtained from the video content source (e.g., the transmitter) 206 can be used to categorize the scenes of the identified program types. Such information from the video content source 206 can be stored in the receiver 100, in for example, the scene library 102. In alternate embodiments of the present invention, user inputs from, for example, the user interface 109 can be used to categorize the scenes of the identified program types. That is similar to identifying program types, a user can preview the video content using, for example, the display 207 and identify different scene categories of the program types in the display 207 by name or title. The titles or identifiers of the various scene categories identified via user input can be stored in the memory means 101 of the receiver 100 in, for example, the scene library 102. In yet alternate embodiments of the present invention, a combination of both, information received from the content source 206 and user inputs from the user interface 109 can be used to categorize the scenes of the identified program types of the video content.

In various embodiments of the present invention, scenes that cannot be accurately categorized using the pre-stored information and/or user inputs can be treated as a new type of scene, and can be accordingly added to the scene library 102. Table 2 illustratively depicts some exemplary scene categories in accordance with the present invention.

TABLE 2
SCENE CATEGORIES

Football - close
Football - mid
Football - far
Football - field
Football - audience
Football - many players
Football - goal
Football - sideline
. . .
General

After identifying the scene categories and the program types in the video content, a location(s) and/or an object(s) of interest in the previously classified fields (e.g., program types and scene categories) can be defined. In one embodiment of the present invention, a user can configure a system of the present invention to automatically add objects and/or locations to the object/location library 104, or to have them stored in a temporary memory (not shown) which can be later added or discarded. In addition, in various embodiments of the present invention, information obtained from the video content source (e.g., the transmitter) 206 can be used to define an object(s) or location(s) of interest. Such information from the video content source 206 can be stored in the receiver 100, in for example, the object/location library 104. Such information from the video source can be generated by a user at a receiver site. That is, in various embodiments of the present invention, a video content source 206 can provide multiple versions of the source content, each having varying areas of interest associated with the various versions, any of which can be selected by a user at a receiver location. In response to a user selecting an available version of the source content, the associated regions of interest can be communicated to the receiver for processing at the receiver location. In an alternate embodiment of the invention however, in response to a user selecting an available version of the source content, video content containing only video associated with the associated regions of interest are communicated to the receiver.

In alternate embodiments of the present invention, user inputs from, for example, the user interface 109 can be used to select regions of interest in the identified program types and categorized scenes. That is similar to identifying program types and categorizing scenes, a user can preview the video content using, for example, the display 207 and define different regions of interest in the display 207 by object and/or location. In various embodiments of the present invention, such user selections can be made at the video content source or at the receiver. The titles or identifiers of the various regions of interest defined via user input can be stored in the memory means 101 of the receiver 100 in, for example, the object/location library 104. In yet alternate embodiments of the present invention, a combination of both, information received from the content source 206 and user inputs from the user interface 109 can be used to define regions of interest in the video content. In accordance with the present invention, a user can manually select objects and/or locations which are desired to be observed, or can alternatively set certain object(s), object types and or locations as regions of interest desired to be viewed in all programming.

Exemplary object types are depicted in Table 3 with respect to received video content containing football programming

TABLE 3

| OBJECTS | DESCRIPTION |
|---|---|
| Football - player 1 | Name, team, . . . |
| Football - player 2 | Name, team, . . . |
| Football - player 3 | Name, team, . . . |
| Football - player 4 | Name, team, . . . |
| Football - coach 1 | Name, team, . . . |
| Football | |
| . . . | |
| General | |

As depicted in Table 3 above, in a close up football scene, objects such as the football, players can be defined as objects of interest. After defining the regions of interest for a subject video content, the selected regions of interest of the video content can be displayed in for example the display 207.

FIG. 4 depicts a flow diagram of a method of the present invention in accordance with an embodiment of the present invention. The method 400 begins at step 401, in which a receiver of the present invention receives a video program and/or an audiovisual signal (AV) signal comprising video content. The method 400 then proceeds to step 403.

At step 403, it is determined whether the program/AV signal is encoded and needs to be decoded. If the signal is encoded and needs to be decoded, the method 400 proceeds to step 405. If the signal does not need to be decoded, the method 400 skips to step 407.

At step 405, the signal is decoded. The method then proceeds to step 407.

At step 407, a region(s) of interest (ROI) is defined. The method 400 then proceeds to step 409.

At step 409, the defined regions of interest can be displayed. That is, at step 409, the corresponding regions of the video signal as defined by the selected and defined regions of interest are displayed or transmitted for display. The method 400 is then exited.

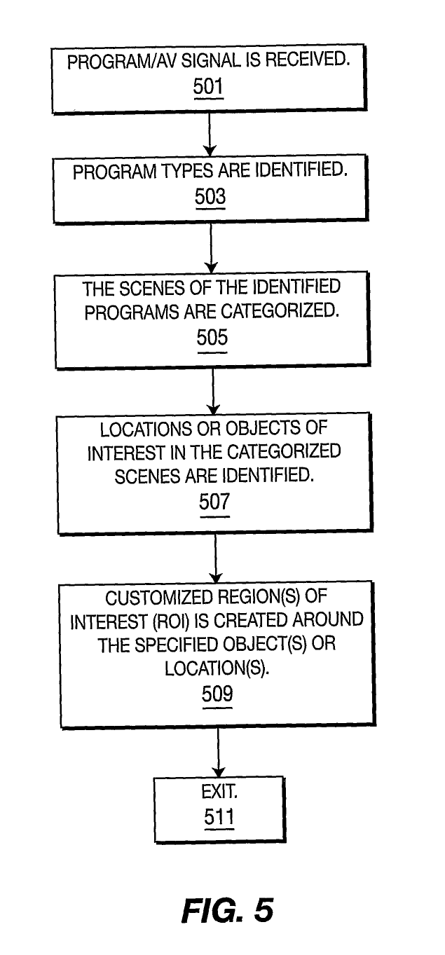

FIG. 5 depicts a flow diagram of a method for defining a region of interest as recited in step 407 of the method 400 of FIG. 4. The method 500 begins in step 501 in which video content is received by, for example, an ROI module of the present invention. The method 500 then proceeds to step 503.

At step 503, the programming of the received video content is identified. That is, at step 503, information (e.g., electronic program guide information) obtained from a video content source (e.g., a transmitter) 206 and/or user inputs from, for example, a user interface 106 can be used to identify the programming types of the received video content. After the type of programming is identified, the method 500 proceeds to step 505.

At step 505, scene classification (categorization) and scene change detection can be determined. That is and as described above, a database can be provided having pre-stored information (504) including a scene library having pre-determined scene types which are stored and available to assist in the process of scene classification. In various embodiments of the present invention, scenes that cannot be accurately classified using the pre-stored information (504) and/or user inputs are treated as a new type of scene, and can be accordingly added to the database. After the subject scenes are classified, the method 500 proceeds to step 507.

At step 507, an object(s) of interest in the previously classified fields (e.g., program types and scene categories) can be identified. For example in one embodiment of the present invention, in a close up football scene, objects such as the football, players can be identified as objects of interest. After the object(s) of interest are identified, the method then proceeds to step 509.

At step 509, a customized region of interest (ROI) is created around the specified object(s) defined in step 507. The method is then exited in step 511.

In alternate embodiments of the present invention, a ROI can also be automatically created in accordance with the present invention according to viewer habits or pre-specified preferred object ‘favorites’, for example, a favorite player, a favorite location, etc. In accordance with the present invention, after a region(s) of interest is defined, the desired object(s) or locations of interest can be tracked from frame to frame and accordingly displayed to a viewer. It should be noted that the size of a ROI can be ever-changing during playback depending upon the specified number of the favorite objects and/or their locations.

In accordance with the present invention, a user can define several levels or sizes of a ROI. As such a ROI can be refined by a user to specify which of several levels or sizes of a ROI the user desires. As such and, in accordance with embodiments of the present invention, a ROI module can create a special or customized level/size ROI to meet a user's needs or preferences. In various embodiments of the present invention, a default level/size can comprise a most frequently used level/size of a ROI, for example.

Although the above methods 400, 500 of FIGS. 4 and 5 are described for an application in which, preferably, the video content is transmitted in full to a receiver device in accordance with an embodiment of the present principles, in alternate embodiments of the present invention, a content source (e.g., transmitter/server) can include at least a ROI module of the present invention. Such source ROI module can be in addition to or in lieu of an ROI module located in a receiver of the present invention.

For example, in an embodiment of the present invention in which a video content is to be communicated to only one receiver, the receiver can communicate to the source (e.g., transmitter) a user's preferences and the transmitter can generate region(s) of interest accordingly. In such embodiments, the amount of video content transmitted to the receiver is reduced thus reducing the bandwidth required for transmission of the content to the receiver, and the amount of processing needed at the receiver is also reduced (which is particularly advantageous since servers/transmitters have more processing power).

In an alternate embodiment of the present invention, various ROIs can be provided at a source side (e.g., at a server/transmitter side) and provided for selection by a user at a receiver side. That is, the sender (server) can generate various preferred regions of interest and transmit each ROI over a separate multicast channel. As such, a user can select/subscribe to a channel having a preferred ROI. Such embodiments advantageously reduce processing time and the number of bits transmitted from the transmitter/server.

In yet an alternate embodiment of the present invention, a ROI of the present invention can be generated at the transmitter/sender according to popular user preferences. More specifically, respective ROIs can be predetermined for respective receivers in accordance with popular choices of the respective receivers and as such the determine ROIs can be transmitted to the respective receivers. It should be noted that the above-mentioned alternate embodiments involving ROI processing at the transmitter side in accordance with the present invention can be especially useful in situations in which processing/transmission capacity is an issue.

Having described preferred embodiments for a method, apparatus and system for generating regions of interest (ROI) in video content (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof.

1. A method for generating a region of interest in video content comprising:
identifying at least one programming type of said video content;
categorizing scenes of at least one of said programming types; and
defining at least one region of interest in at least one of said scenes by identifying at least one of a location and an object of interest in said scenes.

2. The method of claim 1, wherein said at least one region of interest is defined via a user input.

3. The method of claim 1, wherein said at least one region of interest is defined by applying at least one of a predetermined location and object of interest in said scenes.

4. The method of claim 1, wherein said at least one region of interest is defined via a combination of a user input and at least one of a predetermined location and object of interest in said scenes.

5. The method of claim 1, wherein said at least one region of interest is defined by applying previous user selections.

6. The method of claim 1, wherein said at least one region of interest is defined by applying information received from a remote source.

7. The method of claim 6, wherein said information received from a remote source comprises at least one of user selections and locations and objects of interest determined at said remote source.

8. The method of claim 1, wherein said at least one defined region of interest is determined at a receiver.

9. The method of claim 1, wherein said at least one defined region of interest is determined at a video content source and communicated to a remote receiver.

10. The method of claim 1, wherein said at least one programming type and said scenes are identified and categorized using received information.

11. The method of claim 10, wherein information for identifying and categorizing said at least one programming type and said scenes are received from a remote source of said video content.

12. An apparatus for generating a region of interest in video content comprising:
a processing module configured to perform the steps of:
identifying at least one programming type of said video content;
categorizing scenes of at least one of said programming types; and
defining at least one region of interest in at least one of said scenes by identifying at least one of a location and an object of interest in said scenes.

13. The apparatus of claim 12 further comprising:
a decoder for decoding received encoded video content.

14. The apparatus of claim 12, further comprising a memory for storing identified programming types and categorized scenes of said video content.

15. The apparatus of claim 14, wherein said identified programming types stored in said memory comprise a programming library.

16. The apparatus of claim 14, wherein said categorized scenes stored in said memory comprise a scene library.

17. The apparatus of claim 14, wherein said identified locations and objects of interest are stored in said memory and comprise an object library.

18. The apparatus of claim 12, further comprising a user interface for enabling a user to identify preferences for defining regions of interest.

19. The apparatus of claim 18, wherein said user interface comprises at least one of a wireless remote control, a pointing device, such as a mouse or a trackball, a voice recognition system, a touch screen, on screen menus, buttons, and knobs.

20. The apparatus of claim 12, wherein said apparatus comprises a playback device.

21. The apparatus of claim 12, wherein said apparatus comprises a receiver.

22. The apparatus of claim 12, wherein said apparatus comprises a transmitter device.

23. A system for generating a region of interest in video content comprising:
a content source for broadcasting said video content;
a receiving device for receiving said video content and configuring said received video content for display;
a display device for displaying said video content from said receiving device; and
a processing module configured to perform the steps of:
identifying at least one programming type of said video content;
categorizing scenes of at least one of said programming types; and
defining at least one region of interest in at least one of said scenes by identifying at least one of a location and an object of interest in said scenes.

24. The system of claim 23, wherein said processing module is located in said receiving device and said receiving device comprises a memory for storing identified programming types and categorized scenes of said video content.

25. The system of claim 24, wherein said receiving device further comprises a user interface for enabling a user to identify preferences for defining regions of interest.

26. The system of claim 23, wherein said processing module is located in said content source and said content source comprises a memory for storing identified programming types and categorized scenes of said video content.

27. The system of claim 26, wherein said content source further comprises a user interface for enabling a user to identify preferences for defining regions of interest.

28. The system of claim 23, wherein said receiving device comprises a video/audio playback device.

29. The system of claim 23, wherein said content source comprises a server.
